(19) United States
(12) Patent Application Publication
(10) Pub. No.: US 2005/0088266 A1
(43) Pub. Date: Apr. 28, 2005

(54) Zero backflow vent for liquid helium cooled magnets

(75) Inventors: Roy A. Mangano, Florence, SC (US); Kathleen W. McGuinness, Florence, SC (US); Limin Zhang, Florence, SC (US)

Correspondence Address: JOSEPH S. HEINO, ESQ., 111 E. KILBOURN AVENUE, SUITE 1400, MILWAUKEE, WI, 53202, US

(73) Assignee: GE Medical Systems Global Technology Company, LLC, Waukesha, WI (US)

(21) Appl. No.: 10/695,074

(22) Filed: Oct. 28, 2003

(51) Int. Cl. H01F 5/00

(52) U.S. Cl. 335/300

(57) ABSTRACT

The zero-backflow vent assembly (100) of the present invention prevents backflow into the magnet cryogen vessel (12) and therefore eliminates magnet icing. In general, the present invention employs a spring loaded valve in the magnet vent turret (38) to prevent the influx of air after a magnet quench event. The magnet vent turret (38) is the interface between the liquid helium vessel (12) in the magnet and the atmosphere (40). A vent stack is employed to channel any cryogenic exhaust gas out of the room, normally to the outside atmosphere (40).

### BACKGROUND OF THE INVENTION

The present invention relates generally to superconducting magnets, and more particularly to an assembly for preventing ambient air from flowing back into a superconducting magnet following magnet quench or burst disk failure.

As is well known, a magnet can be made superconductive by placing it in an extremely cold environment, such as by enclosing it in a cryostat or pressure vessel containing a cryogen. This extremely cold environment effectively reduces resistance in the magnet coils to negligible levels, such that when a power source is initially connected to the coil to introduce a current flow through the coils, the current will continue to flow through the coils even after power is removed, thereby maintaining a magnetic field. Such a magnetic field finds wide application in the field of magnetic resonance imaging (MRI). The cryogen most often used with MRI superconducting magnets is helium, which exists in a liquid state at approximately 4.2° K. The liquid helium cools the superconducting wire so that the magnet can be energized, or “ramped” up to full operational field. Once the magnet is ramped, it maintains the particular magnetic field until the magnet is deenergized. Deenergizing of the magnet, or ramping down, is a planned event which occurs in the normal course of operations. The magnet may also be quenched, which is an unplanned event.

During normal superconducting operation of the magnet, the cryostat must be a closed or sealed system so as to prevent leakage of helium liquid and helium gas from the cryostat, both of which would deplete liquid helium from the cryostat reservoir. In the event of an undesired magnet quench or reversion of the magnet to a non-superconductive state, however, the rapid and potentially dangerous high pressure buildup of helium gas in the cryostat requires pressure relief through rapid venting of the gas to the atmosphere outside of the magnet. When the magnet quenches, the magnetic field energy can be represented by the equation P=V*I wherein V is the voltage in the coil, I is the current in the coil, and P is the amount of power that is converted to heat. That heat, in turn, boils the liquid helium. As the liquid helium heats, and then boils, it rapidly expands. The ratio of liquid to vapor expansion for helium is approximately 770:1, resulting in a nearly instantaneous pressure increase in the magnet vessel. Obviously, this is a potentially hazardous condition for medical staff and the patient. Less obvious is the potential for damage to the system, which can be extremely expensive.

A replaceable rupture disk, or burst disk, may be interposed within a magnet vent assembly, which disk is designed to rupture at a predetermined pressure thereby opening the cryostat to an atmospheric vent. Even in normal operation, however, the liquid helium vessel always operates slightly above atmospheric pressure. The burst disk performs the function of remaining sealed to maintain pressurization of the liquid helium vessel and to prevent air inflow. If the maximum safe pressure is exceeded, the burst disk fractures, thereby allowing the magnet to vent, normally to the outside. The atmospheric vent may be a vent stack which extends from the roof of a building or from the roof of a motor vehicle which is used to transport a portable MRI system contained within it.

Once ruptured, the burst disk must be replaced. More immediate, however, is the need to seal the system once the pressure in the cryostat has dissipated. That is, in the event of a magnet quench, the burst disk performs its function by preventing damage to the magnet caused by the sudden pressure increase. After the liquid helium vessel in the magnet vents, and the pressure inside the magnet vessel returns to atmospheric level, the liquid helium vessel remains open, thus allowing for the inflow of air into the magnet. That is, once the pressure in the helium vessel has dissipated and the helium vessel pressure reaches equilibrium with atmosphere, the magnet stops venting. At this point, the magnet begins to function as a cryogenic pump, that is, it draws in air to the cool surfaces of the helium vessel. The air is then frozen on the cool surfaces, leading to a condition known as magnet icing which continues until the magnet warms further or the burst disk is replaced. Air consists primarily of nitrogen and oxygen, which have freezing temperatures of 63° K. and 54° K., respectively. When air is permitted to flow into the liquid helium vessel, the air freezes and magnet icing occurs.

Thus there is a need for a system that prevents magnet icing in a superconducting magnet after a magnet quench or a burst disk rupture. The present invention provides such a device.

### SUMMARY OF THE INVENTION

The zero-backflow vent system of the present invention prevents backflow into the magnet liquid helium vessel and therefore eliminates magnet icing. The present invention opens in the event of a magnet quench, but closes after pressure is relieved. In general, the present invention employs a magnet vent turret. The magnet vent turret is the interface between the liquid helium vessel in the magnet and the atmosphere. A burst disk is located downstream of the helium vessel in the vent turret. A vent stack is employed to channel any cryogenic exhaust gas out of the room, normally to the outside.

In order to prevent magnet icing, the present invention provides a zero-backflow vent system to prevent ambient air from entering the helium vessel after a quench. The zero-backflow vent system is generally comprised of a plunger assembly with a valve face, the valve face being designed to form a seal against a valve seat. In general, a load spring provides the closing force to maintain a sealed system during normal operation. The amount of load force required to keep the valve face sealed against the valve seat can be adjusted using a load adjustment screw to increase or decrease the length, and thus the overall force applied by, the load spring.

When the magnet quenches, the pressure within the helium vessel rises, which subsequently increases the amount of force acting against the plunger face. In operation, the load spring is adjusted to allow the magnet to vent during a quench. Therefore, when the force generated by the pressure of the helium gas expanding is greater than the spring force, the plunger assembly opens and allows the magnet to vent. After a short duration of venting, the magnet pressure is relieved, the spring load overcomes the pressure load, and the plunger face reseats on the valve seat, sealing the magnet against icing.

The foregoing and other features of the system of the present invention will be apparent from the detailed description that follows.

### BRIEF DESCRIPTION OF THE DRAWINGS

FIG. 1 is a simplified cross-sectional view of a superconducting magnet and burst disc assembly.

FIG. 2 is a simplified cross-sectional view of a superconducting magnet incorporating an embodiment of the present invention in the closed position.

FIG. 3 is a simplified cross-sectional view of a superconducting magnet incorporating an embodiment of the present invention in the open position.

### DETAILED DESCRIPTION

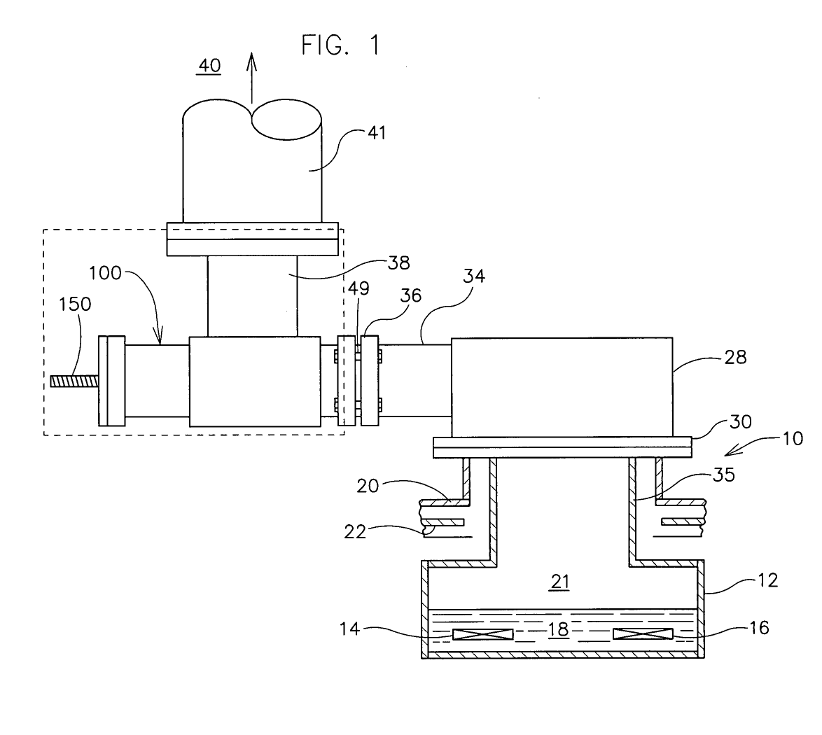

Referring now to the drawings in detail, wherein like numbered elements correspond to like elements throughout, FIG. 1 illustrates a recondensing superconducting magnet system, generally identified 10. The system 10 includes a cryostat or helium pressure vessel 12 (when liquid helium is the cryogen), which vessel 12 is shown schematically in reduced size and which encloses a plurality of magnet coils 14, 16 in liquid helium 18. The helium pressure vessel 12 is enclosed within a surrounding vacuum vessel 20 and intermediate members such as a thermal radiation shield 22. Helium gas 21 forms above the liquid helium 18 through the boiling of the liquid helium 18 in providing cryogenic temperatures to the superconducting magnet system 10. In this fashion, the extreme cold maintains current flow through the magnet coils 14, 16 after a power source, which source is initially connected to the coils 14, 16, is disconnected due to the absence of electrical resistance of the cold magnet coils 14, 16, thereby maintaining a strong magnetic field in the bore of the magnet. Helium gas 21 which forms may be recondensed back to liquid helium 18 by a mechanical refrigerator (not shown) or be vented to the atmosphere.

In an embodiment of the system described herein, a service turret 28 is bolted to a collar 30 by a plurality of bolts. The collar 30 is connected to the interior of the helium vessel 12 by a first section of vent pipe 35 which provides external access for electrical leads (not shown) and for service purposes. A second section of vent pipe 34 connects between the magnet vent/service turret 28 and a burst disk assembly 36 to an exhaust vent assembly 38 which is connected to the outside atmosphere 40 through vent piping 41. The burst disk assembly 36 provides a barrier between the vent pipe 34 and the exhaust vent assembly 38 during normal operation of superconducting magnet 10. The vent pipe 35 is of relatively large diameter, approximately 3 inches, for example, with section of vent pipe 34 being of even larger diameter.

During an undesired quenching or discontinuance of superconducting operation of the superconducting magnet assembly 10, as much as 1,800 liters of liquid helium can be boiled off in as little as 20 seconds. This creates tremendous pressure which must be vented to the atmosphere 40 outside the building that houses the superconducting magnet assembly 10 in order to prevent damage to the superconducting magnet assembly 10. The rapid venting of helium gas 21 to the atmosphere 40 is made possible by the presence of a burst disk. The burst disk is designed to rupture at a predetermined pressure above that produced during normal superconducting magnet operation.

As shown in FIG. 1, the burst disk is interposed between an o-ring face seal (magnet side) and Teflon gasket (vent side) that are used to properly seal the burst disk against leakage of helium gas 21 during normal operation. Bolts 49 around the circumference of the burst disk are used to secure the burst disk although use of other mean for securing the burst disk are also possible.

Unfortunately, and as discussed above, while the burst disk provides protection against damage to the superconducting magnet assembly 10 due to the extreme pressure increase caused by liquid helium 18 boiling off, it cannot prevent magnet icing. Magnet icing occurs when the burst disk has ruptured, the liquid helium 18 has boiled off and the pressure within the helium vessel 12 has been equalized with that of the atmosphere 40. The helium vessel 12 is then open to the ambient atmosphere 40 and, because of its extremely cold state, functions as a cryogenic pump, drawing in air until the burst disk can be replaced. The air then freezes as it comes in contact with the super-cooled surfaces within the liquid helium vessel 12.

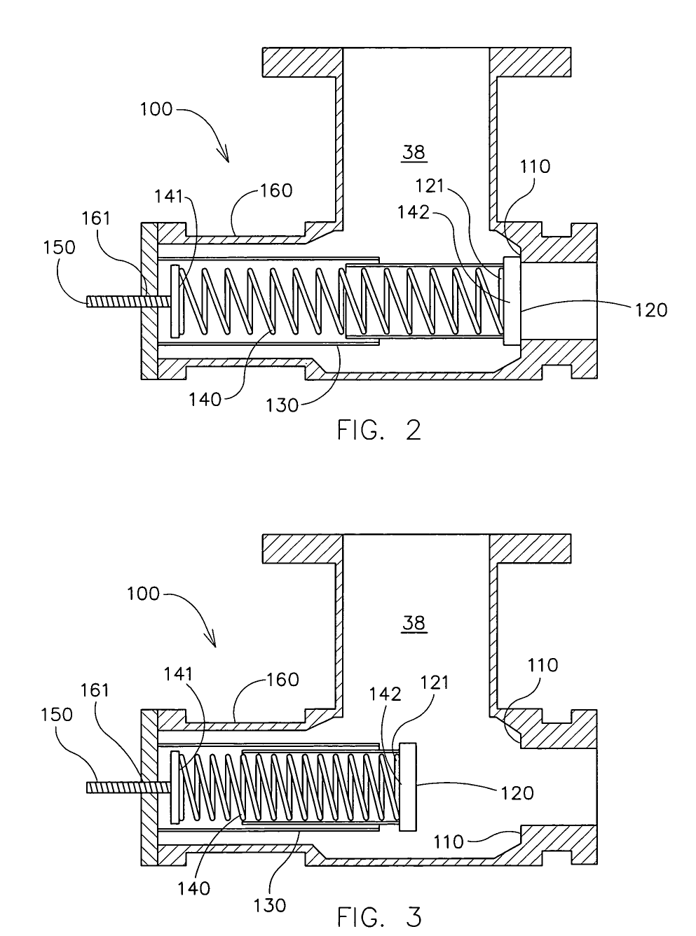

Referring now to FIGS. 2 and 3, The present invention provides a zero backflow vent assembly, generally identified 100, generally comprised of a valve seat 110, a valve face 120, a plunger assembly 130, a spring 140 and a load adjustment screw 150. In location, the zero backflow vent system is located in the vent assembly 38 slightly downstream of the burst disk, or on the atmosphere side 40 of the burst disk.

In operation, the zero backflow vent system 100 simply prevents the backflow of air into the liquid helium vessel 12 by closing the vent assembly 38 after pressure is equalized following a magnet quench. During a magnet quench, pressure behind the burst disk would increase to the point that the burst disk is ruptured. At that point, pressure on the valve face 120 would be so high as to overcome the force provided by the load spring 140 and helium gas 21 would be permitted to vent. At some point, the pressure in the liquid helium vessel 12 would diminish, and thus the force exerted on the valve face 120 would likewise diminish and the valve spring 140 would overcome the force exerted on the valve face 120. The valve spring 140 would then return the valve face 120 to the closed position, thus preventing air from entering the liquid helium vessel 12 and freezing.

The zero backflow vent system 100 of the present invention is located within the vent assembly 38 on the atmosphere side 40 of the burst disk. The vent assembly 38 of the present invention differs from prior vent assemblies in that a spring recess area 160 is provided opposite the burst disk but within the vent assembly 38. The vent stack 41 then remains the same with the only addition being the zero backflow vent assembly 100. In general, the vent assembly 38 will be designed having a valve seat 110 on the atmosphere side 40 of the burst disk. The valve seat 110 simply provides a sealing resting point for the valve face 120. The valve face 120 abuts the valve seat 110 and is the object exposed to the increase in pressure of the helium gas 21 and to the remnants of the ruptured burst disk.

Behind the valve face 120 is a load spring 140, enclosed in a plunger assembly 130. The load spring 140 is designed to provide enough resilience to push the valve face 120 back into the valve seat 110 when the pressure inside the liquid helium vessel 12 has returned to a safe level. The valve face 120 then prevents air from the atmosphere from entering the liquid helium vessel 12 and freezing. The load spring 140 is also calibrated such that in the event of a rise in pressure in the liquid helium vessel 12, it would open again to permit liquid helium 18 to boil off.

The load spring 140 is enclosed in a plunger assembly 130 in order to prevent pieces of the burst disk from becoming tangled in the load spring 140. In general, the spring 140 is compressed between the back of the valve face 121 and a spring backing plate 141. Circumferentially, the spring 140 is enclosed by the plunger assembly 130. A portion of the load spring 140 and the spring backing plate 141 is housed in the spring recess area 160. The length of the load spring 140, and thus the force exerted by it, is adjustable using the load adjustment screw 150. The load adjustment screw 150 rotates within a threaded aperture 161 in the spring recess area 160, permitting magnet engineers to adjust the length/force of the spring 140 by threading the load adjustment screw 150 further in, or unthreading it, thus permitting the user to ensure that the valve face 120 is always resting firmly against the valve seat 110.

In summary, the present invention provides a zero backflow vent assembly for a cryostat pressure relieving vent system 100 for a cryogen cooled superconducting magnet 10 having a cryogen gas vent attached to the cryostat and connected to an exhaust vent 41, said cryogen gas vent being installed to vent cryogen gas 21 from the cryostat to the atmosphere in the event of an undesired pressure buildup comprising; a spring recess area 160 within the cryogen gas vent; a valve seat integrated with the cryogen gas vent opposite the spring recess area 160; a threaded aperture 161 within the spring recess area 160 opposite the cryogen gas vent; a threaded rod 150 threaded into the threaded aperture 161; a spring backing plate 141 at the end of the threaded rod 150; a spring 140 having a first end attached to the spring backing plate 141 and a second end 142; and a valve face 120 attached to the second end of the spring 142. The spring 140 of the present invention may alternately permit the valve face 120 to move towards the exhaust vent in the event of an undesired pressure buildup and seal the valve face 120 against the valve seat 110 when the pressure inside the cryostat has subsided to safe levels. The spring of the present invention may also be enclosed in a plunger assembly 130. The present invention may also provide for adjustable spring 140 by either moving the spring backing plate 141 either closer to or further away from the valve face 120 by threading or unthreading the threaded rod 150. Normally, the zero backflow vent system 100 of the present invention is positioned downstream of a burst disk assembly.

Accordingly, an improved device for preventing the backflow of air into a liquid helium vessel has been presented. While the applicants believe they have provided a full and complete disclosure of the invention has been made, additional advantages and modifications will readily occur to those skilled in the art. Therefore, the invention in its broader aspects is not limited to the specific details disclosed and described herein. Accordingly, various modifications may be made without departing from the spirit or scope of the general inventive concept as defined by the appended claims and their equivalents.

### Parts List

10 superconducting magnet system
12 helium pressure vessel
14 magnet coil
16 magnet coil
18 liquid helium
20 vacuum vessel
21 helium gas
22 thermal radiation shield
24 vent pipe
28 service turret
30 collar
32 bolts
34 vent piping
35 pipe
36 burst disk assembly
38 exhaust vent assembly
40 outside atmosphere
41 vent piping
49 bolts
100 zero backflow vent system
110 valve seat
120 valve face
121 back of 120
130 plunger assembly
140 load spring
141 spring backing plate
150 load adjustment screw
160 spring recess area
161 threaded aperture

1. A zero backflow vent assembly (100) for a cryogen cooled superconducting magnet having a cryogen gas vent attached to the helium pressure vessel (12) and connected to an exhaust vent comprising:
a valve in the cryogen gas vent interposed between the helium pressure vessel (12) and the exhaust vent (38);
said valve opening in the event of an undesired pressure buildup in the helium pressure vessel (12) and closing when the pressure inside the helium pressure vessel (12) has subsided to safe levels.

2. The zero backflow vent assembly of claim 1 wherein the valve is comprised of a valve seat (110) integrated with the vent assembly (38).

3. The zero backflow vent assembly of claim 2 wherein the valve is further comprised of:
a valve face (120);
means for alternately permitting the valve face to move towards the exhaust vent (38) in the event of an undesired pressure buildup and to seal the valve face (120) against the valve seat (110) when the pressure inside the helium pressure vessel has subsided to safe levels.

4. The zero backflow vent assembly of claim 3 wherein a spring (140) comprises the means for alternately permitting the valve face (120) to move towards the exhaust vent (38) in the event of an undesired pressure buildup and to seal the valve face (120) against the valve seat (110) when the pressure inside the helium pressure vessel (12) has subsided to safe levels.

5. The zero backflow vent assembly of claim 4 wherein the spring (140) is enclosed in a plunger assembly (130).

6. The zero backflow vent assembly of claim 5 wherein the spring (140) is interposed between the spring backing plate (141) and the back of the valve face (121).

7. The zero backflow vent assembly of claim 6 wherein the spring backing plate (141) is attached to the cryogen gas vent (38) using a threaded rod (150).

8. The zero backflow vent assembly of claim 7 wherein the threaded rod (150) is threaded through a threaded aperture (161) in the cryogen gas vent (38).

9. The zero backflow vent assembly of claim 8 wherein the length of the spring (140) is adjustable by either moving the spring backing plate (141) either closer to or further away from the valve face (120) by threading or unthreading the threaded rod (150).

10. The zero backflow vent assembly of claim 9 wherein the cryogen gas vent has a spring recess area (160) that partially surrounds the zero backflow vent assembly.

11. The zero backflow vent assembly of claim 10 wherein the zero backflow vent assembly is positioned downstream of a burst disk assembly (36).

12. A zero backflow vent assembly for a pressure relieving vent system for a cryogen cooled superconducting magnet having a cryogen gas vent attached to the cryostat and connected to an exhaust vent, said cryogen gas vent being installed to vent cryogen gas from the cryostat to the atmosphere in the event of an undesired pressure buildup comprising:
a spring loaded valve in the cryogen gas vent interposed between the pressure vessel (12) and the exhaust vent (38);
said valve opening in the event of an undesired pressure buildup in the pressure vessel and closing when the pressure inside the pressure vessel has subsided to safe levels.

13. The zero backflow vent assembly of claim 12 wherein the spring loaded valve is further comprised of a valve seat (110) integrated with the cryogen gas vent (38).

14. The zero backflow vent assembly of claim 13 wherein the valve is further comprises:
a valve face (120), said valve face (120) being pressed against the valve seat (110) during normal operation of the magnet;
said spring alternately permitting the valve face (120) to move towards the exhaust vent (38) in the event of an undesired pressure buildup and sealing the valve face (120) against the valve seat (110) when the pressure inside the pressure vessel has subsided to safe levels.

15. The zero backflow vent assembly of claim 4 wherein the spring (140) is enclosed in a plunger assembly (130).

16. The zero backflow vent assembly of claim 5 wherein the spring (140) is interposed between the spring backing plate (141) and the back of the valve face (121).

17. The zero backflow vent assembly of claim 6 wherein the spring backing plate (141) is attached to the cryogen gas vent (38) using a threaded rod (150).

18. The zero backflow vent assembly of claim 7 wherein the threaded rod (150) is threaded through a threaded aperture (161) in the cryogen gas vent (38).

19. The zero backflow vent assembly of claim 8 wherein the length of the spring (140) is adjustable by either moving the spring backing plate (141) either closer to or further away from the valve face (120) by threading or unthreading the threaded rod (150).

20. The zero backflow vent assembly of claim 9 wherein the cryogen gas vent has a spring recess area (160) that partially surrounds the zero backflow vent assembly.

21. The zero backflow vent assembly of claim 10 wherein the zero backflow vent assembly is positioned downstream of a burst disk assembly (36).

22. A zero backflow vent assembly (100) for a pressure relieving vent system for a cryogen cooled superconducting magnet having a cryogen gas vent attached to the cryostat and connected to an exhaust vent, said cryogen gas vent being installed to vent cryogen gas from the cryostat to the atmosphere in the event of an undesired pressure buildup comprising:
a spring recess area (160) within the cryogen gas vent;
a valve seat (110) integrated with the cryogen gas vent opposite the spring recess area;
a threaded aperture (161) within the spring recess area (160) opposite the cryogen gas vent;
a threaded rod (150) threaded into the threaded aperture (161);
a spring backing plate (141) at the end of the threaded rod (150);
a spring (140) having a first end attached to the spring backing plate (141) and a second end (142); and
a valve face (120) attached to the second end of the spring (142).

23. The zero backflow vent assembly of claim 22 wherein the spring (140) alternately permits the valve face (120) to move towards the exhaust vent (38) in the event of an undesired pressure buildup and seals the valve face (120) against the valve seat (110) when the pressure inside the pressure vessel has subsided to safe levels.

24. The zero backflow vent assembly of claim 23 wherein the spring (140) is enclosed in a plunger assembly (130).

25. The zero backflow vent assembly of claim 24 wherein the length of the spring (140) is adjustable by either moving the spring backing plate (141) either closer to or further away from the valve face (120) by threading or unthreading the threaded rod (150).

26. The zero backflow vent assembly of claim 25 wherein the zero backflow vent assembly (100) is positioned downstream of a burst disk assembly (36).
